(19) United States
(12) Patent Application Publication
(10) Pub. No.: US 2007/0129890 A1
(43) Pub. Date: Jun. 7, 2007

(54) Device for relative positioning and locating persons

(76) Inventor: Yu-Ying Yang, Taipei City (TW)

Correspondence Address: Troxell Law Office Pllc;Suite 1404, 5205 Leesburg Pike, Falls Church, VA, 22041, US

(21) Appl. No.: 11/518,386

(22) Filed: Sep. 11, 2006

(30) Foreign Application Priority Data
Sep. 30, 2005 (TW) 094134165

(51) Int. Cl. G01C 21/00; G05D 1/02

(52) U.S. Cl. 701/300; 701/213

(57) ABSTRACT

A method for relative positioning and locating persons and device thereof, which uses a GPS (Global Positioning System) to lock relative position coordinate data of a plurality of unit devices or a single unit device, and the data is saved within a memory unit, whereafter a wireless communication transmission method is used to mutually connect data (including identification data and coordinate data) between each of the unit devices. Finally, central processor units carry out calculations on and comparison of the data, and an operating unit switches to the desired corresponding unit devices, thereby enabling a display unit to rapidly display relative direction and distance between the corresponding unit devices, thus achieving the objective to rapidly locate persons.

### BACKGROUND OF THE INVENTION

(a) Field of the Invention

The present invention relates to a method for relative positioning and locating persons and device thereof, and more particularly to a method for relative positioning and locating persons and device that uses a wireless communication transmission method from a plurality of unit devices or a single unit device to mutually connect data between each of the unit devices (coordinate data obtained by identification data and GPS (Global Positioning System) positioning), thereby achieving the objective to rapidly locate direction and distance between corresponding unit devices.

(b) Description of the Prior Art

So-called GPS (Global Positioning System) was originally established by the United States Department of Defense for military purposes, when at that time 24 fixed point synchronization artificial satellites were launched and placed into orbit around the earth, thereby enabling any open area on the earth to simultaneously receive signals transmitted by at least three artificial satellites; these signals are then used to calculate the distance from the three artificial satellites. Because the three artificial satellites separately transmit spherical surface shaped electromagnetic waves, thus, a receiver positioned on the concentric circle of each of the electromagnetic waves enables position location of the receiver to be known from the point of intersection formed by the three electromagnetic waves. Modern technology positioning art is able to achieve a positioning accuracy below 6-12 meters.

Furthermore, current wireless communication technology includes RF (Radio Frequency), Bluetooth, 3G (Third-Generation), AMPS (Advanced Mobile Phone Standard), CDMA (Code Division Multiple Access), CDMA ONE Code Division Multiple Access ONE), CDMA 2000 (art developed from CDMA ONE), EDGE (Enhanced Date Rates for Global Evolution), GPRS (General Packet Radio Services), GSM (Global System for Mobile Communications), PHS (Personal Handy-phone System), UMTS (Universal Mobile Telecommunications System), WCDMA (Wideband Code Division Multiple Access), infrared ray wireless transmission, and so on. Wherein application range of RF transmission is considerably extensive, and its operating principle uses a transmitter to transmit a wireless electric wave of specific frequency that actuates a receiver to transmit back data within a chip, and then the original receiver is used to receive the data, thereby achieving one method of data transmission, which pertains to wireless communication art that can be used without the need for establishing a base station.

The inventor of the present invention has designed a unit device, which is structured to comprise a GPS module, a wireless communication module, a central processor, a memory unit, a display unit, an operating unit and connecting ports, wherein the GPS module located within the unit device is able to lock position coordinate data of the unit device, and the position coordinate data is then further saved within the memory unit. The wireless communication module is formed by joining a transmitter and a receiver. ID (Identification Data) and coordinate data from corresponding unit devices are simultaneously mutually transmitted and received, whereupon the central processor carries out calculations and comparison, and the display unit displays direction and distance of relative positions, thereby achieving the objective of rapid location. Moreover, searching distance can be expanded to obtain positional information on an even greater number of people or groups.

### SUMMARY OF THE INVENTION

The inventor of the present invention, having accumulated years of experience in related arts, attentively and circumspectly carried out extensive study and exploration to ultimately design a new improved a method for relative positioning and locating persons and device thereof.

A primary objective of the present invention is to provide the method for relative positioning and locating persons and device thereof with GPS (Global Positioning System) modules to lock position coordinate data of a plurality of unit devices or a single unit device, and then use a wireless communication method to transmit the data to achieve the objective to rapidly locate relative direction and distance between each of the unit devices

In order to achieve the aforementioned objective, each of the unit devices of the method for relative positioning and locating persons and device thereof is structured to comprise an outer case, a GPS module, a wireless communication module, a central processor, a memory unit, a display unit, an operating unit and connecting ports, all of which are connected to the central processor.

Furthermore, when using a single unit device, coordinate data of a starting point or original point position is set by means of the GPS module, whereafter the coordinate data is recorded and saved within the memory unit located within the unit device, Thereafter direction and distance of new positions can be continuously validated relative to the original fixed point after moving. When using a plurality of the unit devices, the plurality of unit devices are first connected in series, and then each of the unit devices are set up with an exclusive ID (Identification Data), whereafter the GPS modules are used to lock coordinate data of each of the unit devices, and then the coordinate data is recorded and saved within the memory unit of each of the unit devices. A transmitter of the wireless communication device in each of the unit devices transmits the individual ID and coordinate data of the unit device, and a receiver of each of the unit devices receives the corresponding individual ID and coordinate data, whereafter the central processor within each of the unit devices carries out calculations and comparison on the data received, and the operating unit located on an upper portion of the unit device is able to switch to corresponding unit devices whenever necessary to obtain relative direction and distance positional data between corresponding unit devices. Hence the present invention has a functional range for use by multiple groups, and expands group operating range and distance.

According to the aforementioned structure, when using a plurality of the unit devices, the connecting ports of the plurality of unit devices or two corresponding unit devices are first connected in series, then a power supply is switched on and each of the unit devices are set up with an exclusive ID, whereafter the GPS module located within each of the unit devices automatically receive signals transmitted by GPS satellites, and the display unit displays whether actuation is normal or not. Position coordinate data obtained by the GPS modules is saved in the memory units, whereafter the wireless communication module within each of the unit devices transmits the IDs and coordinate data, and the wireless communication modules of the other corresponding unit devices simultaneously receive the aforementioned data. The central processor within each of the unit devices then carries out calculations on and comparison of the coordinate data between corresponding unit devices, and the operating unit is able to switch the ID of two corresponding different unit devices, whereupon, the display unit immediately displays direction and distance of the two corresponding unit devices. Operation is considerably convenient, and the method for multilayer transmission of data using the aforementioned device not only achieves the objective to rapidly locate direction and distance between corresponding unit devices, but also expands searching distance to obtain positional information on an even greater number of people or groups.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a schematic view depicting method of use of a single unit device according to the present invention.

FIG. 2 shows a schematic view depicting method of use of a plurality of the unit devices according to the present invention.

FIG. 3 shows a layout for hardware of the unit device according to the present invention.

FIG. 4 shows a structural elevational view of the unit device according to the present invention.

FIG. 5 shows a structural elevational view of another embodiment of the unit device according to the present invention.

FIG. 6 shows a schematic view depicting operation of component members within the unit device according to the present invention.

FIG. 7 shows a flow chart depicting the method of use of the single unit device according to the present invention.

FIG. 8 shows a flow chart depicting the method of use of a plurality of the unit devices according to the present invention.

FIG. 9 shows a schematic view depicting use of a transmission transfer method for communication according to the present invention.

### DETAILED DESCRIPTION OF THE PREFERRED EMBODIMENTS

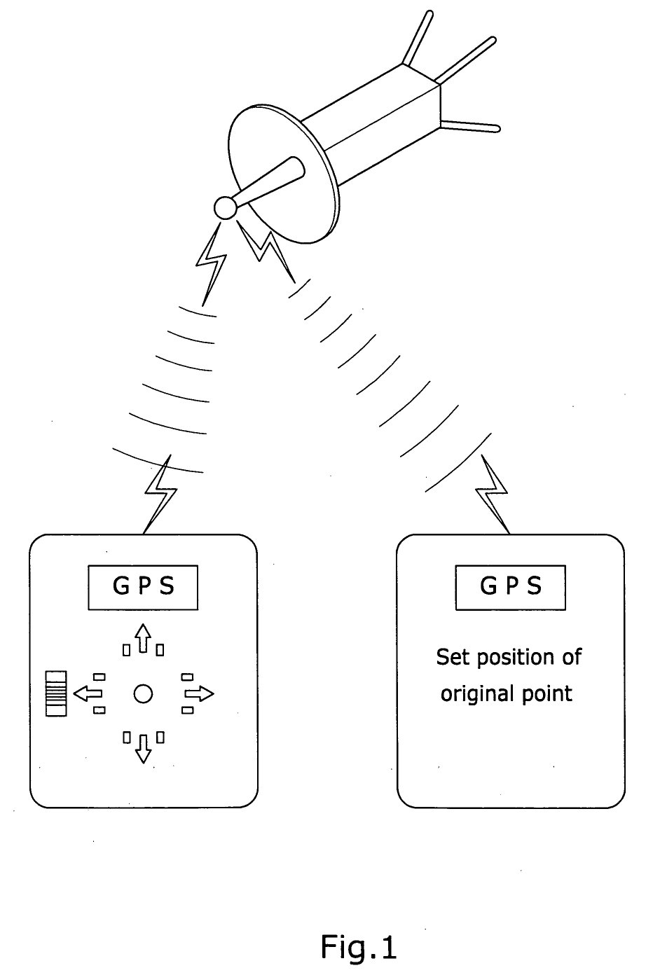

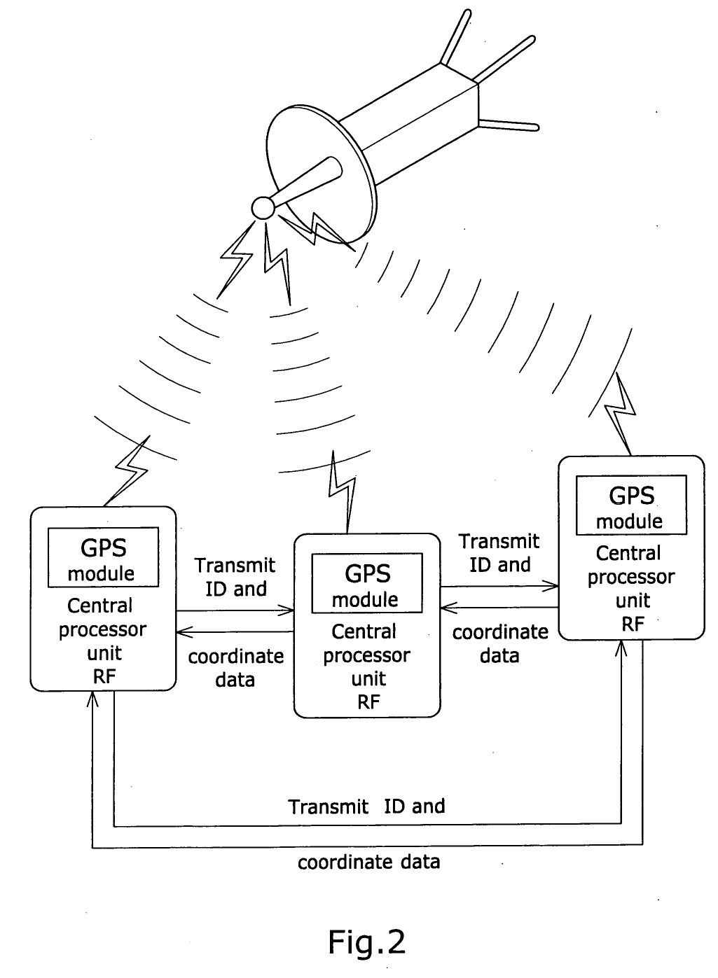

Referring to FIGS. 1 and 2, which show a method for relative positioning and locating persons and device thereof of the present invention, wherein FIG. 1 depicts use of a single unit device, which employs a GPS (Global Positioning System) to set position of a starting point or original point, whereafter this data is recorded and saved to a memory unit within the unit device, and which is able to continuously validate direction and distance of new positions relative to the original point after moving. Furthermore, when using a plurality of unit devices, the plurality of unit devices are first connected in series, whereafter each of the unit devices are set up with an exclusive ID (Identification Data), then the GPSs are used to lock coordinate data of each of the unit devices. Moreover, a transmitter in each of the unit devices transmits the individual ID and coordinate data of the unit device using an RF (Radio Frequency) transmission method, and receivers of corresponding unit devices receive the transmitted IDs and coordinate data, whereafter the central processor within each of the unit devices carries out calculations and comparison to obtain relative direction and distance positional data between relative unit devices. Moreover, mutual switching to corresponding unit devices of a plurality of the unit devices enables data from a unit device beyond the transmission range of wireless communication can be obtained by means of a transmission transfer method, thereby expanding functionality to simultaneous use by multiple groups, and using the RF transmission method expands group operating range and distance.

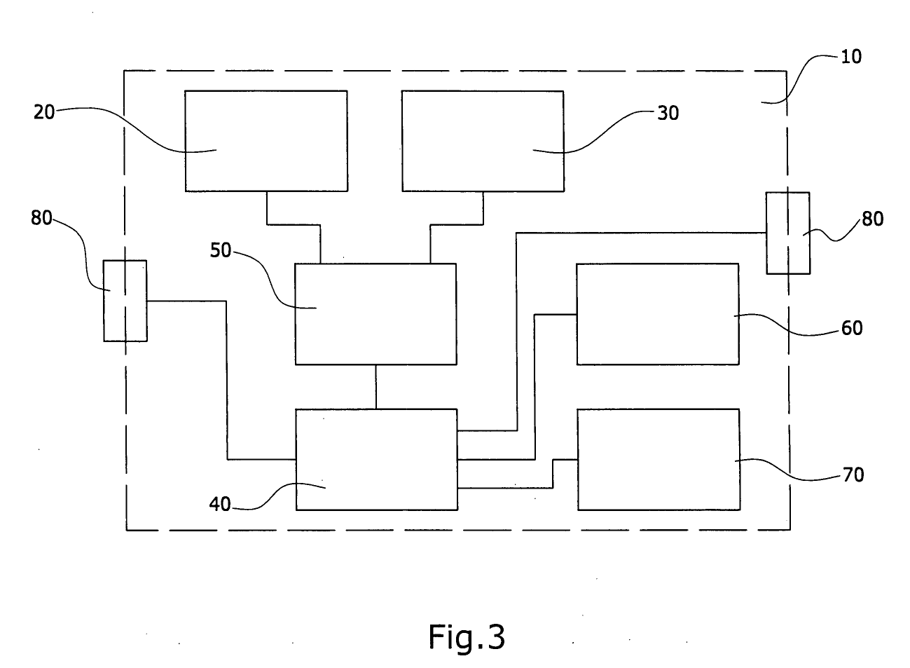

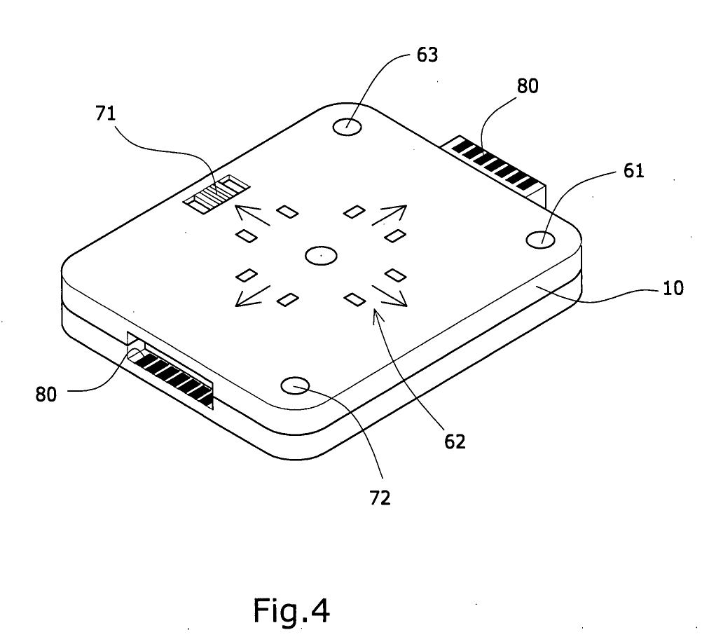

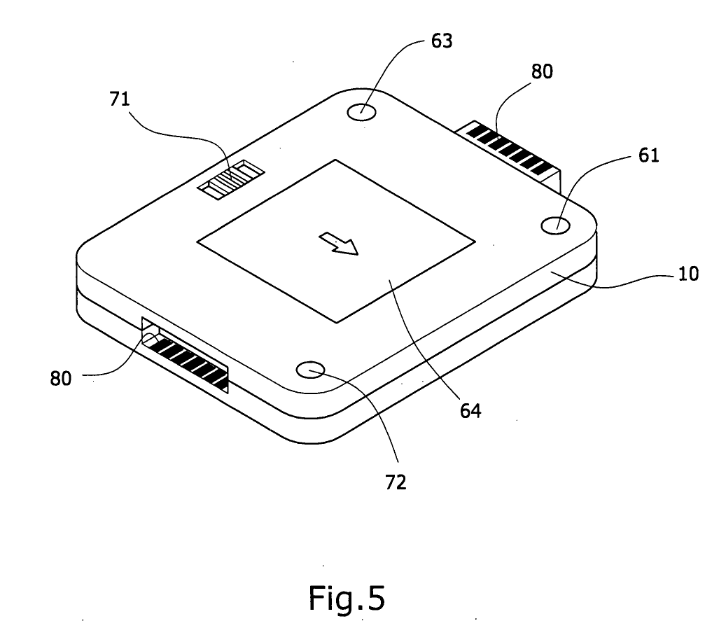

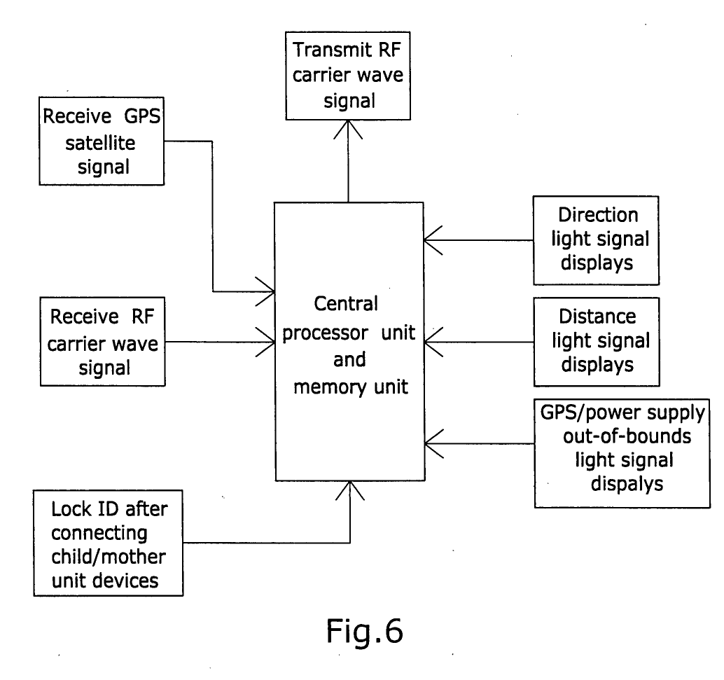

Referring to FIGS. 3, 4, 5 and 6, wherein each of the unit devices are structured to comprise an outer case 10, a GPS module 20, a wireless communication module 30, a central processor 40, a memory unit 50, a display unit 60, an operating unit 70 and connecting ports 80, all of which are connected to the central processor 40. Moreover, the central processor 40 controls operation of all the other component members. The wireless communication module 30 comprises a transmitter and a receiver, a RF (Radio Frequency) module being the most widely used in the current market, and can indeed be combined and used with the various types of telecommunication related communication technology in the future, such as Bluetooth, 3G (Third-Generation), AMPS (Advanced Mobile Phone Standard), CDMA (Code Division Multiple Access), CDMA ONE (Code Division Multiple Access ONE), CDMA 2000 (art developed from CDMA ONE), EDGE (Enhanced Date Rates for Global Evolution), GPRS (General Packet Radio Services), GSM (Global System for Mobile Communications), PHS (Personal Handy-phone System), UMTS (Universal Mobile Telecommunications System), WCDMA (Wideband Code Division Multiple Access), infrared ray wireless transmission, and so on. Moreover, various light signals of the display unit 60 are located on the outer case 10, for example: a power supply indicator light 61, direction indicator lights 62, a function setting light 63, and so on, or an LCD (Liquid Crystal Display) 64 or other display screens can be located on the outer case 10 to enable direct displaying of direction and distance. Furthermore, a switch key 71 of the operating unit 70 and an ID setting button 72 are further located on the outer case 10, and the connecting ports 80 are disposed at appropriate positions on the outer case 10, which enable the setting of data when a plurality of the unit devices are connected in series. The number of connecting ports 80 can be one or a plurality, or an adapter method can be used to extend the connecting ports 80. Moreover, the connecting ports 80 can be a transmission port having specifications complying with RSR232 (Recommended Standard), USB (Universal Serial Bus) or IE1394 (Institute of Electrical and Electronic Engineers) standards. Furthermore, the aforementioned display unit 60 is joined to the operating unit 70, hence, using a current popular touch display screen as the display unit 60 enables operational selection to be carried out directly on a surface of the touch display screen and display relative distance and direction positional data of each of the unit devices. In addition, an accumulator, such as a general battery, built-in lithium cell, and so on, can be used within each of the unit devices of the present invention to supply power, which apart from increasing operational use time and convenience, and providing effectiveness to function in different operating environments, moreover, the unit device can be configured to function in coordination with a simple solar energy charger and accumulator device to extend utility time of the unit devices and increase convenience thereof, thereby expanding the type of environment and area in which the unit device can function (including environments having no power supply, such as: mountain areas, deserts, offshore, and so on). Furthermore, a MIC (microphone) and speaker can be further added within the unit device, thereby increasing functionality to transmit sound messages, and the memory unit 50 is able to increase memory capacity of the unit device (the memory unit 50 can be a memory expansion card circulating in the current market, including SD (Secure Digital), MMC (Multimedia Card), MMC 4.0 (Multimedia Card 4.0), Mini SD (Mini Secure Digital), RS MMC (Reduced Size Multimedia Card), RS MMC 4.0 (Reduced Size Multimedia Card 4.0), xD (xD-Picture Card), MS (Memory Stick), MS DUO (Memory Stick DUO), MS PRO (Memory Stick PRO), MS MAGIC GATE (Memory Stick MAGIC GATE), CF (CompactFlash), MD (MicroDrive), and so on). Furthermore, the unit device can be joined to a larger display screen to enable increasing display of control numbers and information on even more unit devices. Moreover, the aforementioned assembled component members within the unit device can be disposed within a mobile communication device, a PDA (Persona Digital Assistant), a PMP (Portable Media Player), a portable computer or a computer peripheral for use thereof, thereby expanding functionality and transmission to control even more information. Furthermore, apart from the aforementioned devices provided with input facility being able to directly input coordinate positions, moreover, data information can be saved to the memory unit 50, and after the central processor 40 has carried out calculations and comparison of data, distance and direction of point position coordinates of the unit device can be calculated. Furthermore, after expanding the memory unit 50, the appropriate operating unit 70 can be used to record the coordinate path passed through by the unit device in the memory unit 50.

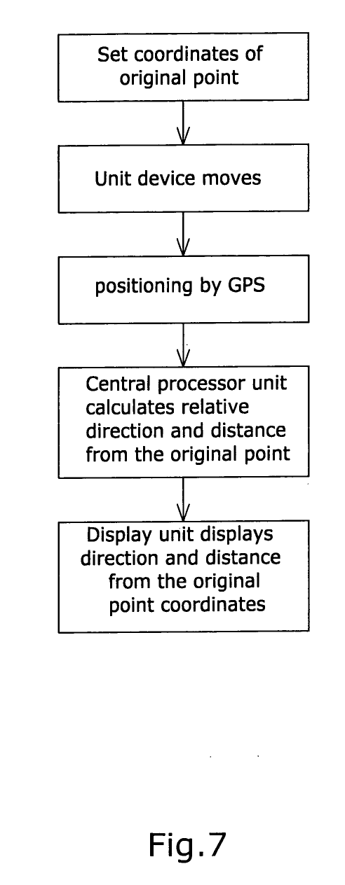

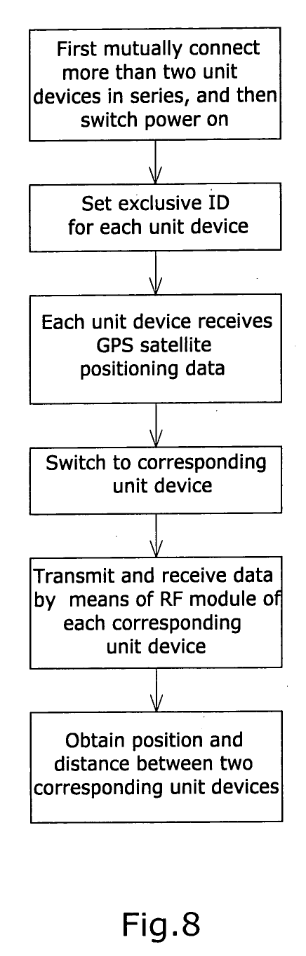

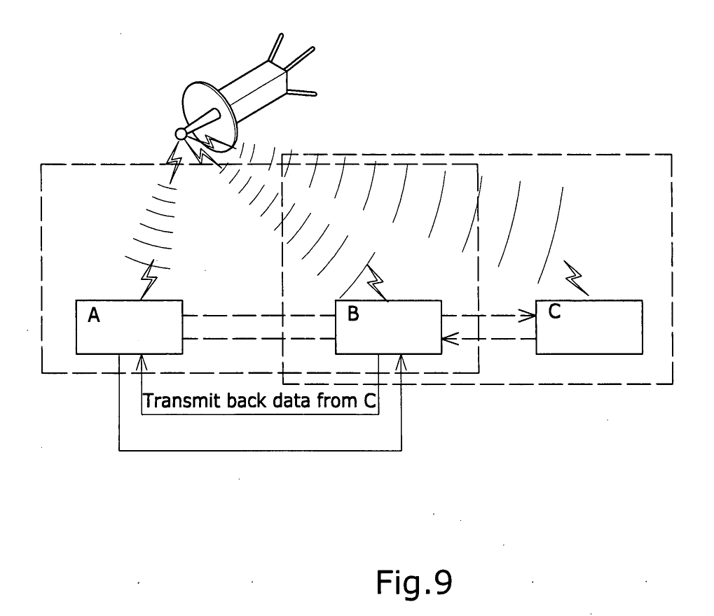

Referring to FIGS. 7 and 8, which show flow charts depicting different methods of use of the present invention, wherein when using the first method of use depicted in FIG. 7, a GPS (Global Positioning System) is used to set position of a starting point or original point, whereafter direction and distance positional data of new positions relative to the original fixed point after movement is continuously validated. Such a method is suitable for general use between family members. In addition, the second method of use depicted in FIG. 8 involves first mutually connecting the connecting ports 80 of an appropriate number of unit devices, then a power supply is switched on and the operating units 70 are used to begin setting exclusive IDs to complete prefix operations. When using the second method, the GPS modules 20 positioned within the unit devices begin to receive satellite signals, and light signals of the appropriate display units 60 display whether actuation is normal or not. Position coordinate data obtained by the GPS modules 20 is saved in the memory units 50, whereafter a transmitter of the wireless communication module 30 within each of the unit devices transmits the IDs together with the coordinate data, which are then received by a corresponding receiver of the wireless communication module 30 within each of the unit devices, thereby enabling the plurality of unit devices to simultaneously receive corresponding IDs and coordinate data of each other. The central processor 40 within each of the unit devices then carries out calculations and comparison, and the operating unit 70 mutually switches to corresponding different unit devices, thereby obtaining coordinate data between two corresponding unit devices. Thereafter, the display unit 60 on the outer case 10 displays direction and distance of two corresponding unit devices. Such a method of use is substantially suitable for use by a group of people who simultaneously set out on a journey. Furthermore, FIG. 9 shows a schematic view depicting use of transmission transfer as a communication method according to the present invention. An example of which is communication technology using wireless communication having transmission transfer effectiveness, which enables multiple groups of people who simultaneously set out on a journey to be connected in series, for instance: group A, group B and group C are able to separately receive satellite positioning data, but are hindered by the communication range of wireless communication, that is, Group A and group B are able to directly communicate, but distance between group A and group C is beyond the communication range. At such a time, because group B is relatively nearer to group C, thus, group A is able to use group B as a transmission transfer point and receive data transmitted to group B from group C, thereby achieving the objective of expanding communication range. In addition, the connecting ports 80 of the unit device enable a portable computer or other processor device (such as: a desktop computer, PDA, and so on) to be connected thereto, thereby enabling the ID of each of the unit devices to be saved within the processor devices. Hence, the wireless communication module 30 within the unit device connected to the aforementioned devices is able to receive position coordinate data of the unit devices of each group, whereupon the central processor 40 within each of the unit devices carries out comparison and calculations, and information regarding relative position and distance of each of the unit devices is successively saved within the aforementioned device. Finally, an administrator or group leader is able to use a relatively large display screen of the aforementioned device to display relative positions and information of the unit devices of all the groups, and transmit the information to related groups or devices.

In conclusion, the method for relative positioning and locating persons and device thereof disclosed in the present invention does not exist in prior art, and has assuredly achieved effectiveness of anticipated objectives. Hence, the present invention clearly complies with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A device for relative positioning and locating persons, comprising:
an outer case;
a central processor installed on a circuit board within the outer case, which is used to carry out calculations on and comparison of coordinate and identification data;
a GPS (Global Positioning System) module installed on the circuit board and electrically connected to the central processor, which is able to connect with GPS artificial satellites to obtain coordinate data of unit devices;
a wireless communication module installed on the circuit board and electrically connected to the central processor, comprising a transmitter and a receiver, wherein the transmitter is used to transmit coordinate data and identification data, and the receiver is used to receive coordinate data and identification data;
a memory unit installed on the circuit board and electrically connected to the central processor, which is able to save the coordinate data and identification data;
a display unit installed on an upper portion of the outer case and electrically connected to the central processor, comprising a power supply indicator light, a direction indicator light and a plurality of function setting lights; the display unit is able to display functional state, direction indication, and so on, of the unit device;
an operating unit installed on the upper portion of the outer case, comprising a switch key and an ID (Identification Data) setting button, and is electrically connected to the central processor, and enables function switching of the unit device, and ID setting when a plurality of the unit devices are being used;
a connecting port installed on the outer case and electrically connected to the central processor, which enables the setting of data when a plurality of the unit devices are connected in series;
a power supply device installed within the outer case, which supplies needed power to the circuit board.

2. The method for relative positioning and locating persons and device thereof according to claim 1, wherein the display unit is an LCD (Liquid Crystal Display) display screen.

3. The device for relative positioning and locating persons according to claim 1, wherein the display unit is a touch display screen, which is electrically connected to the operating unit.

4. The device for relative positioning and locating persons according to claim 1, wherein the connecting port is a RSR232 (Recommended Standard) transmission port.

5. The device for relative positioning and locating persons according to claim 1, wherein the connecting port is a USB (Universal Serial Bus) transmission port.

6. The device for relative positioning and locating persons according to claim 1, wherein the connecting port is a, IE1394 (Institute of Electrical and Electronic Engineers) transmission port.

7. The device for relative positioning and locating persons according to claim 1, wherein the power supply device is a general battery.

8. The device for relative positioning and locating persons according to claim 1, wherein the power supply device is an accumulator.

9. The device for relative positioning and locating persons according to claim 8, wherein the accumulator functions in coordination with a simple solar energy charger.

10. The device for relative positioning and locating persons according to claim 1, wherein a MIC (microphone) and a speaker are installed in the unit device.

11. The device for relative positioning and locating persons according to claim 1, wherein the memory unit is an expansion memory.

12. The device for relative positioning and locating persons according to claim 1, wherein the device for relative positioning and locating persons is disposed within a mobile communication device.

13. The device for relative positioning and locating persons according to claim 1, wherein the device for relative positioning and locating persons is disposed within a PDA (Personal Digital Assistant).

14. The device for relative positioning and locating persons according to claim 1, wherein the device for relative positioning and locating persons is disposed within a PMP (Portable Media player).

15. The device for relative positioning and locating persons according to claim 1, wherein the device for relative positioning and locating persons is disposed within a portable computer.

16. The device for relative positioning and locating persons according to claim 1, wherein the device for relative positioning and locating persons is disposed within a computer equipment.

17. A method for relative positioning and locating persons, and when using a single unit device comprises:
a first step, wherein coordinate data of original point position is set by means of a GPS (Global Positioning Device) module of a unit device connecting with GPS artificial satellites;
a second step, wherein the coordinate data is recorded and saved within a memory unit of the unit device;
a third step, wherein direction and distance of new positions are continuously validated relative to the original point after moving;

18. A method for relative positioning and locating persons, and when using a plurality of unit devices comprises:
a first step, wherein the plurality of unit devices are first connected in series, and then each of the unit devices are set up with an exclusive ID (Identification Data);
a second step, wherein coordinate data of each of the unit devices is set by means of a GPS module within each of unit devices connecting with GPS artificial satellites, and the coordinate data is recorded and saved within a memory unit of each of the unit devices;
a third step, wherein a transmitter of a wireless communication device in each of the unit devices transmits the individual ID and coordinate data of the unit device;
a fourth step, wherein a receiver of each of the unit devices receives the corresponding individual ID and coordinate data;
a fifth step, wherein a central processor within each of the unit devices carries out calculations and comparison on the data received;
a sixth step, wherein an operating unit located on an upper portion of the unit device switches to corresponding unit devices whenever necessary to obtain relative direction and distance positional data between corresponding unit devices.
